(19) United States
(12) Patent Application Publication
(10) Pub. No.: US 2011/0123853 A1
(43) Pub. Date: May 26, 2011

(54) SECONDARY BATTERY

(75) Inventor: Young-Chang Kim, Yongin-Si (KR)

(73) Assignee: Samsung SDI Co., Ltd., Yongin-si (KR)

(21) Appl. No.: 12/953,383

(22) Filed: Nov. 23, 2010

(30) Foreign Application Priority Data
Nov. 25, 2009 (KR) 10-2009-0114635

(51) Int. Cl. H01M 2/04; H01M 2/10

(52) U.S. Cl. 429/175; 429/186

(57) ABSTRACT

A secondary battery including an electrode assembly, a can to house the electrode assembly, and electrical insulators that expand to secure the electrode assembly in the can, by absorbing a significant amount of liquid.

### CROSS-REFERENCE TO RELATED APPLICATION

This application claims the benefit of Korean Patent Application No. 10-2009-0114635, filed on Nov. 25, 2009, in the Korean Intellectual Property Office, the disclosure of which is incorporated herein, by reference.

### BACKGROUND

1. Field

One or more embodiments of the present disclosure relate to a secondary battery.

2. Description of the Related Art

In general, secondary batteries include a cylindrical electrode assembly having a center pin coupled thereto, a cylindrical can to which the electrode assembly is coupled, an electrolyte injected into the can to enable lithium ions to move, and a cap assembly coupled to the can to prevent the electrolyte from leaking and the electrolyte assembly from escaping. Secondary batteries generally have a capacity of about 2000 to about 4000 mAh and are usually used for notebook PCs, digital cameras, camcorders, etc., which require a large capacity of electric power. For example, a number of secondary batteries may be connected in series or in parallel and are assembled in a hard pack of a predetermined shape, with a protective circuit mounted thereon to be coupled to an electronic appliance.

In addition, secondary batteries are manufactured as follows: a negative electrode plate coated with a negative electrode active material, a separator, and a positive electrode plate coated with a positive electrode active material are laminated together. An end of the resulting laminate is coupled to a rod-shaped winding shaft, and the laminate is wound into an approximately cylindrical shape, to form an electrode assembly. Then, a center pin is inserted into the electrode assembly and the electrode assembly is inserted into a cylindrical can. An electrolyte is injected into the cylindrical can, and a cap assembly is coupled to the cylindrical can to complete a cylindrical lithium ion battery. In order to prevent such secondary batteries from exploding and igniting in cases of overcharging, the battery is provided with a safety vent which deforms when the internal pressure in the battery rises due to overcharging, and a circuit board which interrupts current as the safety vent deforms. The safety vent and the circuit board are also referred to together as current interruption devices (CIDs) and are included as part of the cap assembly.

### SUMMARY

One or more exemplary embodiments of the present disclosure include a secondary battery including an electrode assembly, wherein movement of which is minimized, thereby reducing the movement of the secondary battery.

According to one or more exemplary embodiments of the present disclosure, a secondary battery includes: an electrode assembly; a can accommodating the electrode assembly; and electrical insulators respectively formed on opposing surfaces of the electrode assembly. The electrical insulators are able to expand by absorbing a significant amount of liquid that fills an interior of the can.

According to various aspects, the electrical insulators may expand by absorbing the significant amount of liquid.

According to various aspects, the electrical insulators may expand upward and downward.

According to various aspects, each of the electrical insulators may be made of a mixture of a component that is able to absorb the significant amount of liquid and a component that is not able to absorb the significant amount of liquid.

According to various aspects, the component that is able to absorb the significant amount of liquid may be polyethylene terephthalate (PET) or polyvinylidene fluoride (PVDF).

According to various aspects, the component that is not able to absorb the significant amount of liquid may be polypropylene (PP) or polyethylene (PE).

According to various aspects, the electrical insulators may each include a first layer formed of a component that is able to absorb the significant amount of liquid and a second layer formed of a component that is not able to absorb the significant amount of liquid.

According to various aspects, each of the electrical insulators may include the first layer and the second layer, in a stacked structure.

According to various aspects, the first layer of each of the electrical insulators may be formed adjacent to the electrode assembly.

According to various aspects, the first layer may be formed of PET or PVDF.

According to various aspects, the second layer may be formed of PP or PE.

According to various aspects, the can may be cylindrical.

According to various aspects, the electrical insulator may be disc-shaped, so as to be accommodated in the can.

According to various aspects, the secondary battery may further include a cap assembly coupled to a top opening of the can.

According to one or more exemplary embodiments of the present disclosure, a secondary battery includes: an electrode assembly; a can accommodating the electrode assembly; a cap assembly coupled to a top surface of the can; a first electrical insulator positioned between the electrode assembly and the cap assembly; and a second electrical insulator positioned between the electrode assembly and the can, wherein any one of the first electrical insulator and the second electrical insulator expands to prevent the electrode assembly from moving inside the can.

According to various aspects, any one of the first electrical insulator and the second electrical insulator may expand in a space between the electrode assembly and the cap assembly.

According to various aspects, any one of the first electrical insulator and the second electrical insulator may expand, by absorbing a significant amount of liquid that fills the interior of the can.

According to various aspects, any one of the first electrical insulator and the second electrical insulator may be made of a mixture of a component that is able to absorb the significant amount of liquid and a component that is not able to absorb the significant amount of liquid.

According to various aspects, the component that absorbs the significant amount of liquid may be PET or PVDF.

According to various aspects, the component that does not absorb the electrolyte may be PP or PE.

According to various aspects, any one of the first electrical insulator and the second electrical insulator may include a first layer formed of a component that is able to absorb the significant amount of liquid and a second layer formed of a component that is not able to absorb the significant amount of liquid.

According to various aspects, any one of the first electrical insulator and the second electrical insulator may include the first layer and the second layer in a stacked structure.

According to various aspects, the first layer of any one of the first electrical insulator and the second electrical insulator, may be formed adjacent to the electrode assembly.

According to various aspects, any one of the first electrical insulator and the second electrical insulator may be formed as a plurality of layers, in which the first layer and the second layer are alternately stacked.

According to various aspects, the first layer may be formed adjacent to the electrode assembly.

According to various aspects, the second electrical insulator may expand in a space between the electrode assembly and the cap assembly in either direction.

According to various aspects, the second electrical insulator may expand by absorbing the significant amount of liquid that fills the interior of the can.

According to various aspects, the second electrical insulator may be made of a mixture of a component that is able to absorb the significant amount of liquid and a component that is not able to absorb the liquid.

According to various aspects, the component that is able to absorb the significant amount of liquid may be PET or PVDF.

According to various aspects, the component that is not able to absorb the significant amount of liquid may be PP or PE.

According to various aspects, the second electrical insulator may include a first layer formed of a component that is able to absorb the significant amount of liquid and a second layer formed of a component that is not able to absorb the significant amount of liquid.

According to various aspects, the second electrical insulator may include the first layer and the second layer, in a stacked structure.

According to various aspects, the first layer of the second electrical insulator may be formed adjacent to the electrode assembly.

According to various aspects, the second electrical insulator may be formed as a plurality of layers in which the first layer and the second layer are alternately stacked.

According to various aspects, the first layer of the second electrical insulator may be formed adjacent to the electrode assembly.

Additional aspects and/or advantages of the present disclosure will be set forth in part in the description which follows and, in part, will be obvious from the description, or may be learned by practice of the disclosure.

### BRIEF DESCRIPTION OF THE DRAWINGS

These and/or other aspects and advantages of the disclosure will become apparent and more readily appreciated from the following description of the exemplary embodiments, taken in conjunction with the accompanying drawings, of which:

FIG. 1 is a schematic perspective view of a secondary battery, according to an exemplary embodiment of the present disclosure;

FIG. 2 is a schematic cross-sectional view taken along a line II-II′ of FIG. 1, according to an exemplary embodiment of the present disclosure;

FIG. 3 is a schematic exploded perspective view of the secondary battery of FIG. 1, according to an exemplary embodiment of the present disclosure;

FIG. 4 is a cross-sectional view of a cap assembly, according to an exemplary embodiment of the present disclosure; and

FIG. 5 is a schematic cross-sectional view of a secondary battery, according to another exemplary embodiment of the present disclosure.

### DETAILED DESCRIPTION

Reference will now be made in detail to the exemplary embodiments of the present disclosure, examples of which are illustrated in the accompanying drawings, wherein like reference numerals refer to the like elements throughout. The exemplary embodiments are described below, in order to explain the aspects of the present disclosure, by referring to the figures.

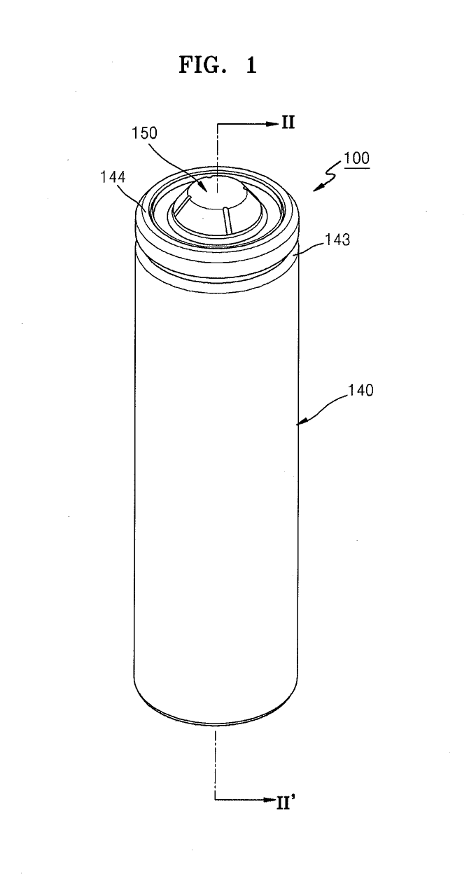

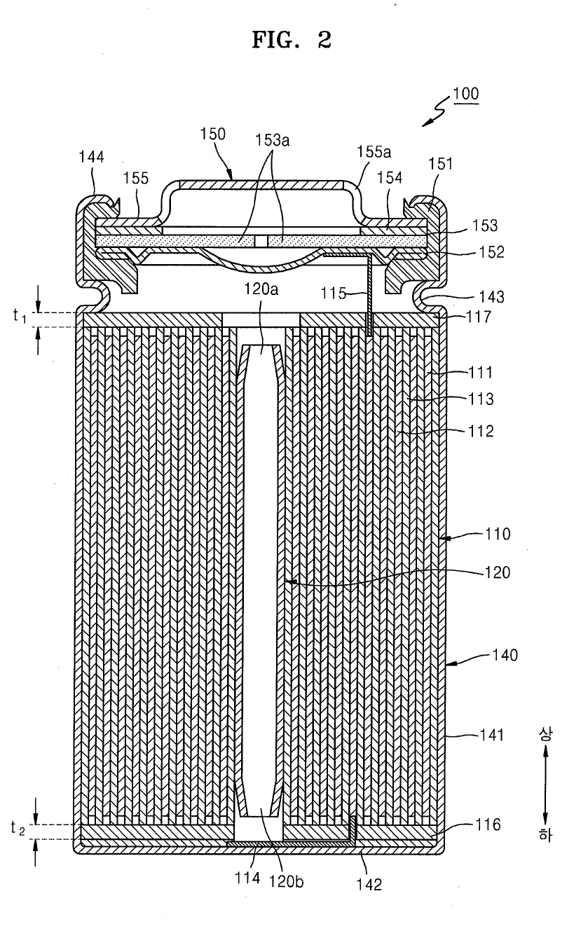

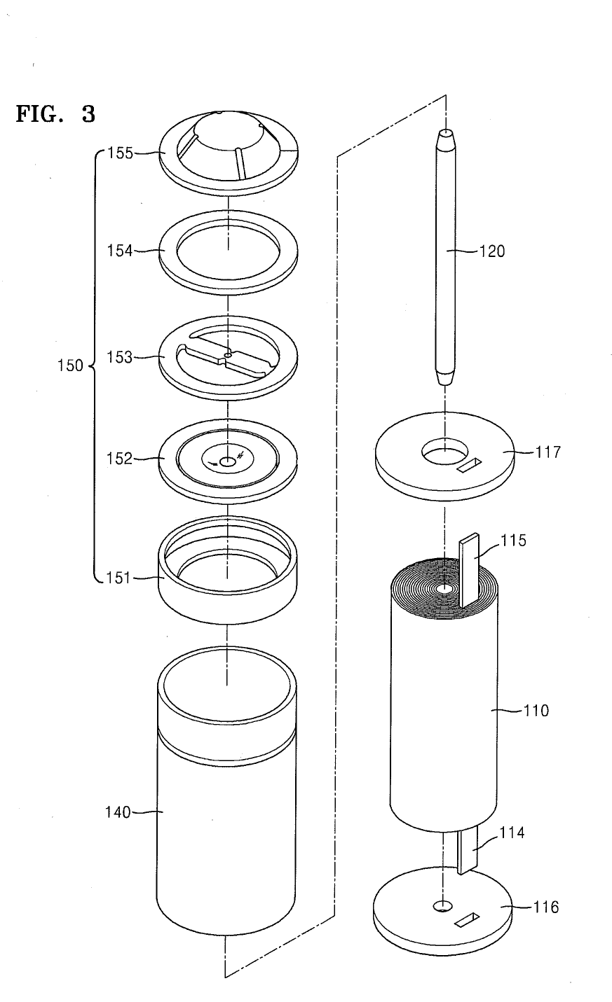

A secondary battery 100 will now be described with reference to FIGS. 1-3. FIG. 1 is a schematic perspective view of a secondary battery 100, according to an exemplary embodiment of the present disclosure. FIG. 2 is a schematic cross-sectional view taken along a line II-II′ of FIG. 1. FIG. 3 is a schematic exploded perspective view of the secondary battery of FIG. 1.

Referring to FIGS. 1 through 3, the secondary battery 100 may include an electrode assembly 110, a center pin 120, a can 140, and a cap assembly 150. The electrode assembly 110 may include an anode plate 111, a cathode plate 112, and a separator 113. The anode plate 11 may be coated with a negative active material, such as graphite. The cathode plate 112 may be coated with a positive active material, such as lithium cobalt oxide (LiCoO₂). The separator 113 is positioned between the anode plate 111 and the cathode plate 112, prevents a short circuit from occurring between the anode plate 11 and the cathode plate 112, and is permeable to lithium ions.

The anode plate 111, the cathode plate 112, and the separator 113 are wound in an approximately cylindrical shape and inserted into the can 140. The anode plate 111 may be a copper (Cu) foil, the cathode plate 112 may be an aluminum (Al) foil, and the separator 113 may be formed of polyethylene (PE) or polypropylene (PP). In addition, the anode plate 111 may include an anode tab 114 welded thereto and protruding a predetermined length downwards. The cathode plate 112 may include a cathode tab 115 welded thereto and protruding a predetermined length upwards, or vice versa. The anode tab 114 may be made of nickel (Ni) and the cathode tab 115 may be made of aluminum (Al).

The center pin 120 is coupled to the electrode assembly 110, at approximately the center of the electrode assembly 110, and prevents the electrode assembly 110 from deforming during charging/discharging of the secondary battery 100. The materials of the anode plate 111, the cathode plate 112, the separator 113, the anode tab 114, and the cathode tab 115 are not limited to the above materials and may easily be changed by one of ordinary skill in the art. The can 140 may be formed of steel, stainless steel, aluminum, or equivalents thereof, but is not limited thereto.

Referring to FIG. 3, the cap assembly 150 includes a gasket 151, a safety vent 152, a circuit board 153, a positive temperature coefficient (PTC) device 154, and a cathode cap 155. The cap assembly 150 may be coupled to a top of the can 140. The gasket 151, which is generally ring-shaped, is coupled to a side of the can 140. The safety vent 152, which is connected to the cathode tab 115, may be coupled to the gasket 151. The safety vent 152 deforms or fractures when the internal pressure of the can 140 rises, so as to fracture the circuit board 153 and/or allow gas to escape from the can 140.

The circuit board 153 is positioned on top of the safety vent 152 and is fractured or broken when the safety vent 152 deforms, to thereby interrupt current flow there through. The PTC device 154 is positioned on top of the circuit board 153 and interrupts current flow in cases of excessive current flow. The cathode cap 155 is positioned on top of the PTC device 154 to connect a cathode voltage (or an anode voltage) to an external device. In addition, the cathode cap 155 may include a plurality of through-holes 155a to allow gas to easily escape. The safety vent 152, the circuit board 153, the PTC device 154, and the cathode cap 155 are surrounded by the gasket 151, to prevent a short circuit from occurring between these components and the can 140. The circuit board 153 has a wiring pattern 153a formed on a surface thereof, which is naturally cut when the circuit board 153 is fractured or broken.

The features of the cap assembly 150 are not limited to the above. For example, the cap assembly 150 may not include the PTC device 154.

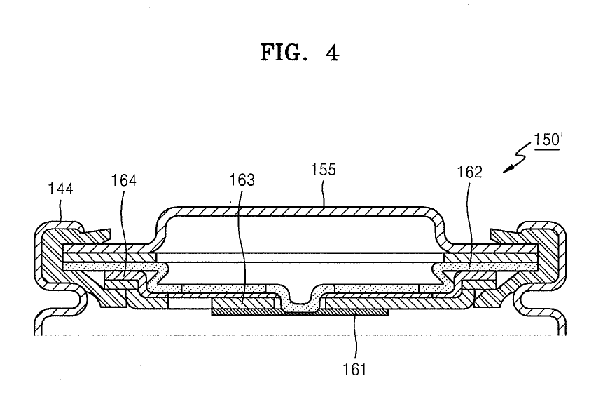

FIG. 4 is a cross-sectional view of a cap assembly 150′, according to an exemplary embodiment of the present disclosure. Referring to FIG. 4, the cap assembly 150′ includes a sub-disk 161, a vent 162, a cap down 163, and an electrical insulator 164. The sub-disk 161 is positioned over the center pin 120. The vent 162 is welded to the sub-disk 161. When the vent 162 deforms, due to increasing internal pressure, the sub-disk 161 and the vent 162 are disconnected to interrupt current flow. The cap down 163 maintains the structure of the sub-disk 161 and the vent 162. The electrical insulator 164 is placed between the cap down 163 and the vent 162 to insulate the same from one another.

The cap assembly 150 will be described mainly with reference to FIGS. 1-3, but is not limited thereto. The operations of the center pin 120 in the cap assembly 150 are the same as in the cap assembly 150′ illustrated in FIG. 4.

Referring to FIG. 2, the can 140 may include a beading part 143 to support a lower portion of the cap assembly 150, which is recessed towards an interior of the secondary battery 100. The can 140 may include a crimping part 144 formed on an upper portion of the cap assembly 150, which is bent towards the interior of the secondary battery 100. The beading part 143 and the crimping part 144 support the cap assembly 150 and firmly fix the cap assembly 150 to the can 140, to secure the cap assembly 150 and prevent an electrolyte from leaking out. The can 140 has an electrolyte (not shown) injected therein, to enable lithium ions to move, the ions being created by electrochemical reactions in the anode and cathode plates 111 and 112 within the secondary battery 100, during charging/discharging. The electrolyte may be a non-aqueous organic electrolyte, such as a mixture of a lithium salt and high-purity organic solvents. In addition, the electrolyte may be a high molecular weight polymer electrolyte, but the type of the electrolyte is not limited thereto.

The center pin 120 may be coupled to the center of the electrode assembly 110. The center pin 120 may be tube-shaped, but the structure thereof is not limited thereto. For example, center pin 120 may be a solid cylinder.

A conventional secondary battery may explode in various circumstances, such as when it is suddenly heated. For example, when a secondary battery is overcharged, an electrolytic solution evaporates from approximately an upper portion of its electrode assembly, and thus, the electric resistance of the upper portion of the electrode assembly increases. As a result, the electrode assembly deforms from the center thereof, causing lithium precipitation. In addition, as the electric resistance in the upper portion of the electrode assembly increases, heat is locally generated in the secondary battery. Thus, the temperature of the secondary battery rapidly increases. In this state, the internal pressure of the secondary battery rapidly increases, due to gas generated from the decomposition of cyclo hexyl benzene (CHB) and biphenyl (BP) electrolytic solution additives, thereby increasing the possibility of an explosion. If the secondary battery explodes, a center pin may be ejected therefrom, causing problems in terms of safety.

In the present exemplary embodiment, at least one end of the center pin 120 deforms, if it collides with an inner surface of the can 140 or the cap assembly 150. Thus, the center pin 120 absorbs the impact energy. As a result, the center pin 120 may not escape from the secondary battery 100.

First and second electrical insulators 117 and 116 may be respectively coupled to opposing ends of the electrode assembly 110. In particular, the first electrical insulator 117 may be positioned between a top surface of the electrode assembly 110 and the cap assembly 150, and the second electrical insulator 116 may be positioned between a bottom surface of the electrode assembly 110 and the can 140.

The first electrical insulator 117 insulates the electrode assembly 110 and the cap assembly 150. The second electrical insulator 116 insulates the electrode assembly 110 and the can 140.

The first and second electrical insulators 117 and 116 may absorb a significant amount of liquid (for example, an electrolytic solution) that fills the interior of the can 140. Thus, the volumes thereof may increase. The first and second electrical insulators 117 and 116 may expand along a long axis of the battery (upward and downward). In other words, a thickness t1 of the first electrical insulator 117 may increase, such that the first electrical insulator 117 may expand to occupy most or all of a space between the electrode assembly 110 and the cap assembly 150. A thickness t2 of the second electrical insulator 116 may increase, such that the second electrical insulator 116 may occupy most or all of a space between the electrode assembly 110 and the can 140.

Accordingly, a first surface of the expanded first electrical insulator 117 may contact the beading part 143 of the can 140, and an opposing second surface of the first electrical insulator 117 may contact the top surface of the electrode assembly 110. In addition, a first surface of the expanded second electrical insulator 116 expanded may contact the bottom surface of the can 140, and an opposing second other surface of the second electrical insulator 116 may contact the bottom surface of the electrode assembly 110.

As the first and second electrical insulators 117 and 116 absorb the liquid (for example, an electrolytic solution) that fills the interior of the can 140, the volumes thereof increase. Thus space for the electrode assembly 110 to move inside of the can 140 decreases. As a result, the electrode assembly 110 may obtain stability in a vertical direction.

The first and second electrical insulators 117 and 116 may be formed of a mixture of an absorbent component, i.e., a component capable of absorbing the liquid (an electrolytic solution or moisture) that fills the interior of the can 110, and a non-absorbent component, i.e., a component does not absorb the liquid. The absorbent component may be polyethylene terephthalate (PET) or polyvinylidene fluoride (PVDF), and the non-absorbent component may be polypropylene (PP) or polyethylene (PE).

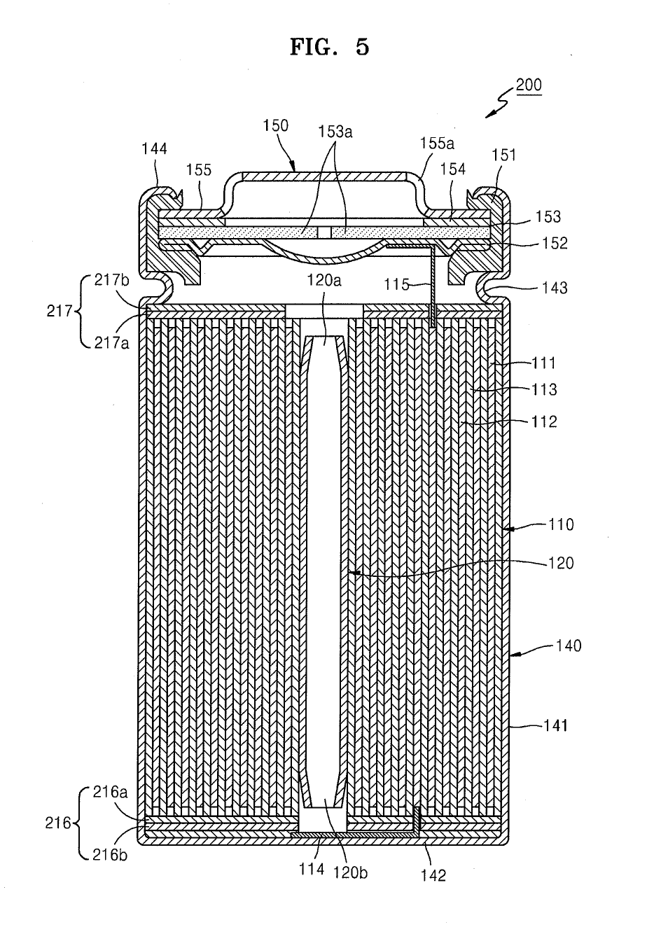

FIG. 5 is a schematic cross-sectional view of a secondary battery 200, according to another exemplary embodiment of the present disclosure. Referring to FIG. 5, the secondary battery 200 is different from the secondary battery 100 of FIG. 1, in that the structure of first and second electrical insulators 217 and 216 is different from the structure of the first and second electrical insulators 117 and 116. In particular, the first electrical insulator 217 may include a first layer 217a and a second layer 217b, and the second electrical insulator 216 may include a first layer 216a and a second layer 216b.

In the first electrical insulator 217, the second layer 217b is stacked on the first layer 217a. In the second electrical insulator 216, the first layer 216a is stacked on the second layer 216b. The first layers 217a and 216a may be formed of the absorbent component, and the second layers 217b and 216b may be formed of the non-absorbent component.

The first layer 217a may be disposed to face the top surface of the electrode assembly 110, and the second layer 217b may be disposed to face the cap assembly 150. Thus, the first layer 217a may contact the top surface of the electrode assembly 110, and a surface of the second layer 217b may contact the beading part 143 of the can 140. The first layer 216a may be formed to contact the bottom surface of the electrode assembly 110, and the second layer 216b thereof may be positioned to contact the bottom surface of the can 140.

Alternatively, the first and second electrical insulators may include multiple layers of the absorbent and non-absorbent components, which are alternately stacked. In this case, one of the absorbent layers is disposed closest to each opposing side of the electrode assembly.

As described above, according to the one or more of the above exemplary embodiments of the present disclosure, movement of an electrode assembly is minimized, thereby preventing the vibration of a secondary battery.

Although a few exemplary embodiments of the present disclosure have been shown and described, it would be appreciated by those skilled in the art that changes may be made in these exemplary embodiments, without departing from the principles and spirit of the present disclosure, the scope of which is defined in the claims and their equivalents.

What is claimed is:

1. A secondary battery comprising:
an electrode assembly;
a can accommodating the electrode assembly; and
a first electrical insulator disposed on a first surface of the electrode assembly, and configured to absorb a significant amount of liquid that it comes in contact with.

2. The secondary battery of claim 1, further comprising a second electrical insulator disposed on a second surface of the electrode assembly such that the first and second surfaces define opposing surfaces of the electrode assembly, the second electrical insulator configured to absorb a significant amount of liquid that it comes in contact with.

3. The secondary battery of claim 2, wherein the electrical insulators are configured to expand after absorbing the significant amount of liquid.

4. The secondary battery of claim 3, wherein the electrical insulators are configured to expand to secure the electrode assembly in the can.

5. The secondary battery of claim 2, wherein each of the first and second electrical insulators comprises a mixture of an absorbent component that is able to absorb the significant amount of liquid and a non-absorbent component that is not able to absorb the significant amount of liquid.

6. The secondary battery of claim 5, wherein the absorbent component comprises polyethylene terephthalate (PET) or polyvinylidene fluoride (PVDF).

7. The secondary battery of claim 5, wherein the non-absorbent component comprises polypropylene (PP) or polyethylene (PE).

8. The secondary battery of claim 2, wherein each of the first and second electrical insulators comprises a first layer formed of an absorbent component that is able to absorb the significant amount of liquid and a second layer formed of a non-absorbent component that is not able to absorb the significant amount of liquid.

9. The secondary battery of claim 8, wherein each of the first and second electrical insulators comprises the first layer and the second layer, in a stacked structure.

10. The secondary battery of claim 9, wherein the first layers are positioned closer to the electrode assembly than the corresponding second layers.

11. The secondary battery of claim 8, wherein each of the first and second electrical insulators comprises a plurality of the first and second layers, the first and second layers being alternately stacked.

12. The secondary battery of claim 2, wherein the can is cylindrical.

13. The second battery of claim 12, wherein the electrical insulators are disc-shaped.

14. The secondary battery of claim 2, further comprising a cap assembly coupled to an opening of the can.

15. A secondary battery comprising:
an electrode assembly;
a can accommodating the electrode assembly;
a cap assembly coupled to the top of the can;
a first electrical insulator positioned between the electrode assembly and the cap assembly; and
a second electrical insulator positioned between the electrode assembly and the bottom of the can,
wherein at least one of the first and second electrical insulators is configured to expand to secure the electrode assembly in the can.

16. The secondary battery of claim 15, wherein the at least one of the first and second electrical insulators is configured to expand by absorbing a significant amount of liquid that fills the interior of the can.

17. The secondary battery of claim 16, wherein at least one of the first and second electrical insulators comprises a mixture of an absorbent component that is able to absorb the significant amount of liquid and a non-absorbent component that is not able to absorb the significant amount of liquid.

18. The secondary battery of claim 16, wherein at least one of the first and second electrical insulators comprises a first layer formed of an absorbent component that is able to absorb the significant amount of liquid and a second layer formed of a non-absorbent component that is not able to absorb the significant amount of liquid.

19. The secondary battery of claim 18, wherein at least one of the first and second electrical insulators comprises the first layer and the second layer in a stacked structure.

20. The secondary battery of claim 19, wherein the first layer is formed closer to the electrode assembly than the second layer.

21. The secondary battery of claim 20, wherein at least one of the first and second electrical insulators comprises a plurality of the first and second layers, the first and second layers being alternately stacked.

22. The secondary battery of claim 21, wherein one of the first layers is disposed closer to the electrode assembly than the second layers.
